(19) United States
(12) Patent Application Publication
(10) Pub. No.: US 2026/0170362 A1
(43) Pub. Date: Jun. 18, 2026

(54) METHOD AND SYSTEM FOR LLM INFERENCE TASK USING QUERY PREDICTION

(71) Applicant: REBELLIONS INC., Seongnam-si (KR)

(72) Inventor: Hyunsung KIM, Seongnam-si (KR)

(21) Appl. No.: 19/408,259

(22) Filed: Dec. 3, 2025

(30) Foreign Application Priority Data
Dec. 13, 2024 (KR) 10-2024-0185989

(51) Int. Cl. G06N 5/04; G06F 40/284

(52) U.S. Cl. CPC G06N 5/04; G06F 40/284

(57) ABSTRACT

An inference task method of a Large Language Model (LLM) inference task system, the method comprising: tokenizing an input query of a user, deriving a predicted query based on the tokenized input query, wherein the predicted query is a sentence predicted based on the input query, determining whether an inference task is performed for the predicted query, and when it is determined that the inference task is performed for the predicted query, performing the inference task for the predicted query to generate an answer to the predicted query.

### CROSS REFERENCE TO RELATED APPLICATION

The present application claims priority to Korean Patent Application No. 10-2024-0185989, filed on Dec. 13, 2024, the entire contents of which is incorporated herein for all purposes by this reference.

### TECHNICAL FIELD

The present disclosure relates to a method and system for LLM inference task using query prediction.

### BACKGROUND

As artificial intelligence (AI) technology advances, AI services utilizing it are becoming more widespread, and specifically, AI models such as LLM (Large Language Model) are proposed to generate answers.

However, as the size and complexity of inference tasks performed and the data transmitted increase, the time it takes to provide answers to user requests may increase, which may lead to a decrease in user satisfaction.

Accordingly, there is a need for a method or system that reduces the first response time and the total inference task time of an LLM inference task and improves the efficiency of the LLM inference task.

### SUMMARY

An object of the present disclosure is to provide an LLM inference method and system to solve the above problems by deriving a predicted query, which is a complete sentence, from a query input by a user by SLM and quickly performing an inference task based on the predicted query, thereby reducing the inference task time.

In order to achieve the object, An inference task method according to an embodiment of the present disclosure includes: tokenizing an input query of a user, deriving a predicted query based on the tokenized input query, wherein the predicted query is a sentence predicted based on the input query, determining whether an inference task is performed for the predicted query, and when it is determined that the inference task is performed for the predicted query, performing the inference task for the predicted query to generate an answer to the predicted query.

A LLM inference task system according to another embodiment of the present disclosure includes: a tokenizer configured to tokenize an input query of a user; an Small Language Model (SLM) configured to derive a predicted query based on the tokenized input query; a Large Language Model (LLM) control unit configured to determine whether an inference task is performed for the predicted query; and an LLM configured to perform the inference task for the predicted query to generate an answer to the predicted query when it is determined that the inference task is performed for the predicted query, wherein the predicted query is a sentence predicted based on the input query.

According to an embodiment of the present disclosure, an answer may be generated using a predicted query derived based on an input query of a user, thereby reducing the inference task time for generating an answer for an inference task and improving user satisfaction.

According to an embodiment of the present disclosure, if the similarity between the embedding vector of the inference task being performed and the embedding vector of the updated predicted query is high, the inference task may be prevented from being interrupted, thereby improving the efficiency of the LLM inference task system using the predicted query.

According to an embodiment of the present disclosure, even if there is a large difference between the embedding vector of the inference task being performed and the embedding vector of the updated predicted query, if it is similar to the embedding vector of the previously performed inference task, the inference task may be performed again using the information of the previously performed inference task, thereby improving the efficiency of the LLM inference task system that uses the predicted query.

### BRIEF DESCRIPTION OF THE DRAWINGS

FIG. 1 is an exemplary block diagram illustrating a neural network application in encoder-decoder format according to an embodiment of the present disclosure.

FIG. 2 is a diagram illustrating an embodiment of tokenizing an input query into tokens in an LM according to an embodiment of the present disclosure.

FIGS. 3A to 3B are diagram illustrating an embodiment of tokenized sentences according to an embodiment of the present disclosure.

FIG. 4 is a diagram illustrating time for the process in which LM performs inference task on a query of an input request.

FIG. 5 is a diagram illustrating an LLM inference task system for reducing response delay time according to an embodiment of the present disclosure.

FIGS. 6A to 6C are diagrams illustrating an embodiment of deriving a predicted query based on a transmitted input query.

FIG. 7 is a flowchart for explaining in detail an inference task method of an LLM inference task system according to an embodiment of the present disclosure.

FIG. 8 is a flowchart for explaining in detail an inference task method of an LLM inference task system according to an embodiment of the present disclosure.

FIG. 9 is a diagram illustrating an embodiment of a device configuration that implements the LLM inference task system of the present disclosure.

FIG. 10 is a diagram illustrating another embodiment of a device configuration that implements the LLM inference task system of the present disclosure.

FIG. 11 is a diagram illustrating another embodiment of a device configuration that implements the LLM inference task system of the present disclosure.

FIG. 12 is a flowchart explaining in detail an inference task method of an LLM inference task system according to an embodiment of the present disclosure.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). Terms such as “circuit (circuitry)” may refer to a circuit in hardware, but may also refer to a circuit in software. The “processor” should be interpreted broadly to encompass a general-purpose processor, a Central Processing Unit (CPU), a microprocessor, a Digital Signal Processor (DSP), a controller, a microcontroller, a state machine, and so forth. Under some circumstances, “processor” may refer to an application-specific integrated circuit (ASIC), a programmable logic device (PLD), or a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or marking data storage, registers, and so on. The memory is said to be in electronic communication with a processor if the processor can read information from and/or write information to the memory. The memory integrated with the processor is in electronic communication with the processor.

In the present disclosure, “each of a plurality of A” may refer to each of all components included in the plurality of A, or may refer to each of some of the components included in a plurality of A.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

In addition, in the following examples, “determining whether it is less than” or “if it is less than” are disclosed, but “determining whether it is less than or equal to” or “if it is less than or equal to” may also be applied to the examples.

Before describing various examples of the present disclosure, terms used herein will be explained.

In the present disclosure, “instruction” may refer to a series of computer-readable commands grouped based on function, which are components of a computer program and executed by a processor.

In the present disclosure, “network” may be implemented as a wired network such as a Local Area Network (LAN), a Wide Area Network (WAN), or a Value Added Network (VAN), or any type of wireless network such as a mobile radio communication network or a satellite communication network.

According to an embodiment of the present disclosure, a language model (LM) may mean a model learned to output statistically the most appropriate output based on an input value (natural language, for example, a user's sentence).

For example, a language model may include a small language model (SLM) and a large language model (LLM). For example, an SLM may mean a language model having a small number of parameters, and an LLM may mean a large language model having parameters ranging from several tens of billions to several hundred billion. For example, SLM may mean a language model having parameters ranging from a few million to hundreds of millions, and LLM may mean a large language model having parameters ranging from 7 billion to 405 billion. SLM may show good performance for specific specialized tasks compared to LLM, and LLM may outperform an SLM in various aspects of natural language processing, including translation and summarization.

For example, an LM including an SLM and/or an LLM may be a neural network application operating in an encoder-decoder format.

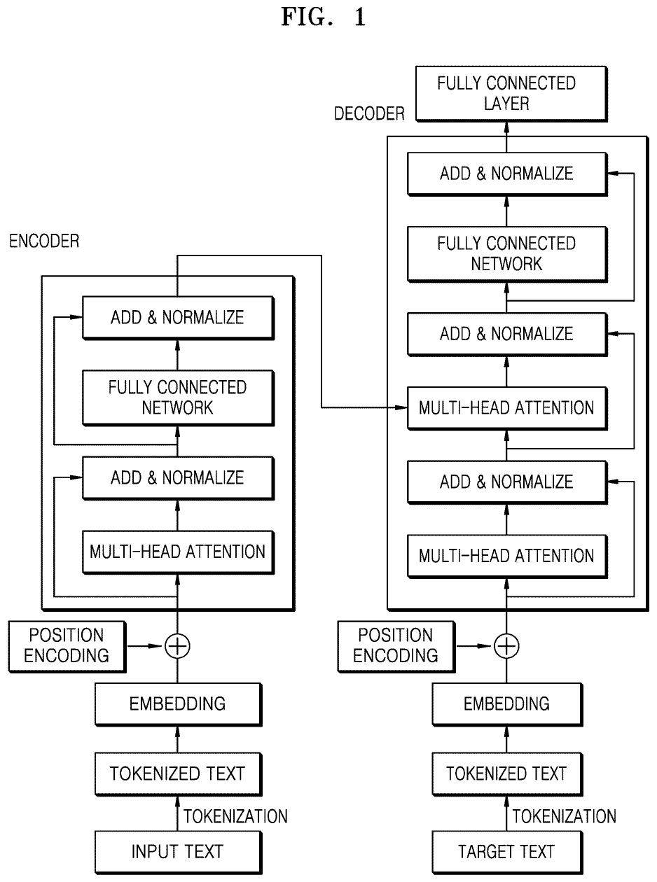

FIG. 1 is an exemplary block diagram illustrating a neural network application in encoder-decoder format according to an embodiment of the present disclosure.

Referring to FIG. 1, the input text may first be tokenized into individual word tokens, and may be encoded through an embedding layer before being input to an encoder. Then, an output value may be derived by adding a positional encoding vector to each embedded word, and the output value may pass through a multi head self-attention layer. Here, the output value may be called embedding. The multi head self-attention layer may be followed by an add & normalize step that performs layer normalization and adds original embedding through skip connections. Finally, the embedding derived through the add & normalize step may be fed into a “fully connected layer”, which is a small multilayer perceptron consisting of two fully connected layers with a nonlinear activation function in between, and then the output embedding may go through the add & normalize step again before being passed to the multi head self-attention of the decoder stage.

Referring to FIG. 1, a decoder of the neural network application is similar to the encoder in overall structure, but differs in that the input and output are different. The encoder of the neural network application may receive input text to be processed, such as translation or summary, and the decoder may generate text on which the processing, such as translation or summary, has been performed.

In addition, for example, the process of generating a word by a decoder may be called a decoding step. In an electronic device performing LLM, when performing a specific decoding step, previously used data may be cached and reused. In order to cache and reuse the previously used data, direct memory access (DMA) may be performed in the electronic device. For example, DMA may mean a function of directly accessing memory such as RAM or a storage device without going through a processing of the CPU in a peripheral device of the device to obtain necessary data.

As described above, LM performs a process of receiving a query and generating a response. This process may be referred to as inference, LM task, or LM operation. The specific details of the LM operation may be described below.

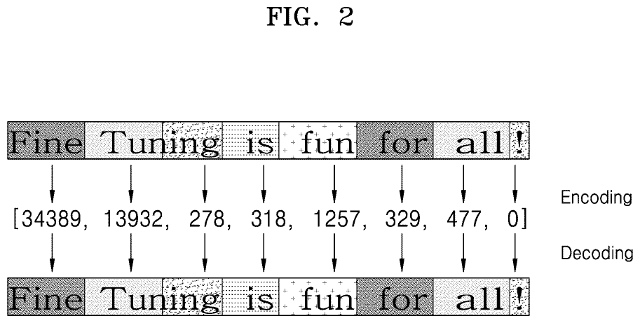

FIG. 2 is a diagram illustrating an embodiment of tokenizing an input query into tokens in an LM according to an embodiment of the present disclosure.

For example, in LM, a query may be decomposed into tokens and converted into numbers. A token may be a word, a morpheme, an individual character, or a subword. An algorithm that decomposes an input sentence into tokens may be referred to as a tokenizer.

As illustrated in FIG. 2, an input query may be decomposed into tokens, and each token may be converted into a corresponding number. For example, the input query may be “Fine Tuning is fun for all!”, which may be decomposed into the tokens “Fine,” “Tun,” “ing,” “is,” “fun,” “for,” “all,” and “!”. The tokens may be encoded and converted into numbers corresponding to each token. Additionally, the numbers may be decoded and converted into tokens corresponding to each number, and a sentence may be generated.

Additionally, for example, an embedding vector may be derived based on the tokenized numbers. For example, an embedding vector may be derived using a trained Transformer for embedding. The Transformer may be referred to as an embedding model.

For example, there may be sentences with similar meanings but different sentence structures, in which case the tokenized numbers of the sentences may differ significantly. Furthermore, there may be sentences with different meanings but similar sentence structures, and the tokenized numbers of the sentences may be similar.

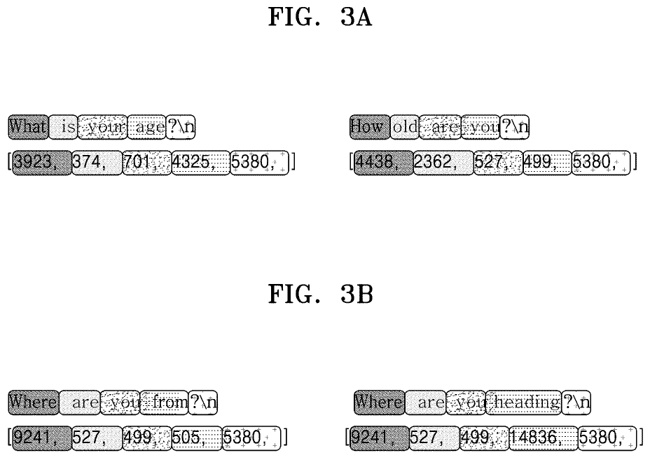

FIGS. 3A to 3B are diagram illustrating an embodiment of tokenized sentences according to an embodiment of the present disclosure.

FIG. 3A may represent tokenized values of sentences having similar meanings but different sentence structures. Referring to FIG. 3A, a first sentence “What is your age?” and a second sentence “How old are you?” may be tokenized. A tokenized value of the first sentence may be derived as [3923, 374, 701, 4325, 5380], and a tokenized value of the second sentence may be derived as [4438, 2362, 527, 499, 5380]. As illustrated in FIG. 3A, a meaning of the first sentence and a meaning of the second sentence are similar, but the tokenized values of the first sentence and the tokenized values of the second sentence may be very different.

FIG. 3B may represent tokenized values of sentences that have different meanings but similar sentence structures. Referring to of FIG. 3B, a third sentence “Where are you from?” and a fourth sentence “Where are you heading?” may be tokenized. A tokenized value of the third sentence may be derived as [9241, 527, 499, 505, 5380], and a tokenized value of the fourth sentence may be derived as [9241, 527, 499, 14836, 5380]. As illustrated in of FIG. 3B, although a meaning of the third sentence and a meaning of the fourth sentence are very different, since the sentence structures are similar, the tokenized values of the third sentence and the tokenized values of the fourth sentence may be derived similarly.

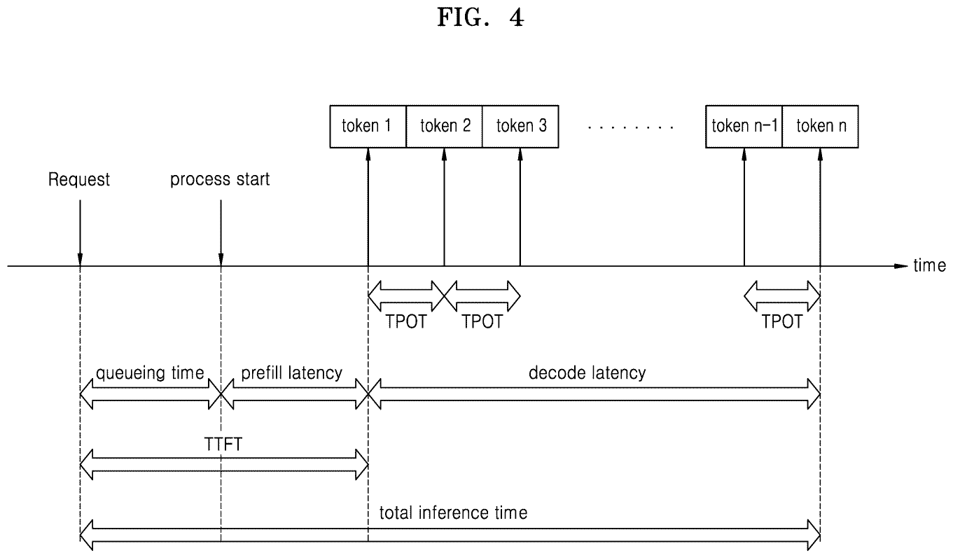

FIG. 4 is a diagram illustrating time for the process in which LM performs inference task on a query of an input request.

When a user's request is input, there may be a queueing time until the LM starts the inference task. When the inference task starts, the LM may perform the inference task based on the query input by the user and generate an answer to the query. The time from when the inference task for the input query begins until a first token of the answer is delivered may be referred to as the prefill latency.

For example, tokens of the answer may be generated sequentially and delivered to the user. The first token of the answer to the predicted full query may be generated and delivered to the user, and the time from the time the user inputs the request to the time the first token of the answer is delivered may be represented as TTFT (Time To First Token). The TTFT may be equal to a sum of the waiting time and the prefill latency. The TTFT may also be represented as a response delay time.

Afterwards, the LM may perform an inference task on the predicted full query to sequentially generate a second token to a nth token of the answer and deliver it to the user. The time interval at which the tokens of the answer are generated may be represented as TPOT (Time Per Output Token, TPOT). That is, the time from when a token of a previous order of the answer was generated until a token of a current order was generated may be represented as TPOT. The time from the generation of the first token to the generation of the last token in the sequence may be represented as decode latency.

As illustrated in FIG. 4, a total inference time may be the sum of the TTFT and the decode latency. In addition, a throughput of LM may be derived as a number of tokens generated per hour. That is, the throughput may be derived as a value obtained by dividing the number of tokens generated by the LM by the total inference time.

The throughput, TTFT, and TPOT may be used as key indicators representing the performance of the LM. Meanwhile, the TTFT, the time from a query input to receiving a response, may be an important indicator of the user experience of conversational applications that utilize LMs such as chatbots that require immediate feedback. That is, the lower the TTFT, the faster and more responsive the initial response of the conversational application may be, thereby improving user satisfaction.

Accordingly, the present disclosure proposes a method to predict an full query based on a partial input query before the user inputs the full query, and to generate an answer by performing an inference task based on the predicted full query. Through the proposed method, LM inference task may be performed in parallel while the user completes the query, which may have the effect of reducing TTFT and overall inference time.

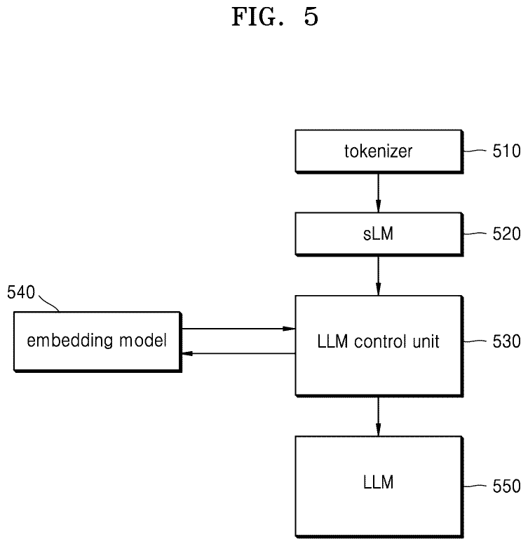

FIG. 5 is a diagram illustrating an LLM inference task system for reducing response delay time according to an embodiment of the present disclosure.

As illustrated in FIG. 5, the LLM inference task system proposed in the present disclosure may include a tokenizer (510), an SLM (520), an LLM control unit (530), an embedding model (540), and/or an LLM (550).

For example, the tokenizer (510) may tokenize a query input by a user. The query input by the user may be referred to as an input query. The tokenizer (510) may detect whether a new token other than unknown has been added each time a user adds a character to an input query, and may tokenize the input query each time a new token is input.

That is, the tokenizer (510) may tokenize an input query of an input incomplete sentence. The tokenizer (510) may determine whether the input query is updated. For example, the tokenizer (510) may determine whether the current input query has been updated by comparing it with a previously output input query, and if the current input query has been updated by comparing it with the previously output input query, a token value of the current input query may be output and transmitted to the SLM (520). Here, the current input query may mean an input query that includes characters input by the user up to a current point in time. Specifically, for example, the tokenizer (510) may detect whether a new, non-unknown token has been added each time a user adds a character to the input query, and if a non-unknown token has been added to the input query, the tokenizer may determine that the input query has been updated. That is, the tokenizer (510) may detect whether an input query has been updated on a token-by-token basis. Through this, calls to the SLM (520) may be minimized.

SLM (520) may predict a full query based on a tokenized input query transmitted from tokenizer (510) and derive a confidence score for the predicted full query. As described above, the tokenizer (510) may tokenize an input query that is an incomplete sentence containing only a part of a sentence input by a user, and transmit the tokenized input query to the SLM (520). However, since a query including the entire sentence is required to perform an inference task in LLM, the present disclosure proposes a method to perform the inference task by deriving a query including the entire sentence based on SLM (520). Here, a query that is a complete sentence predicted based on the input query may be referred to as a full query or predicted query.

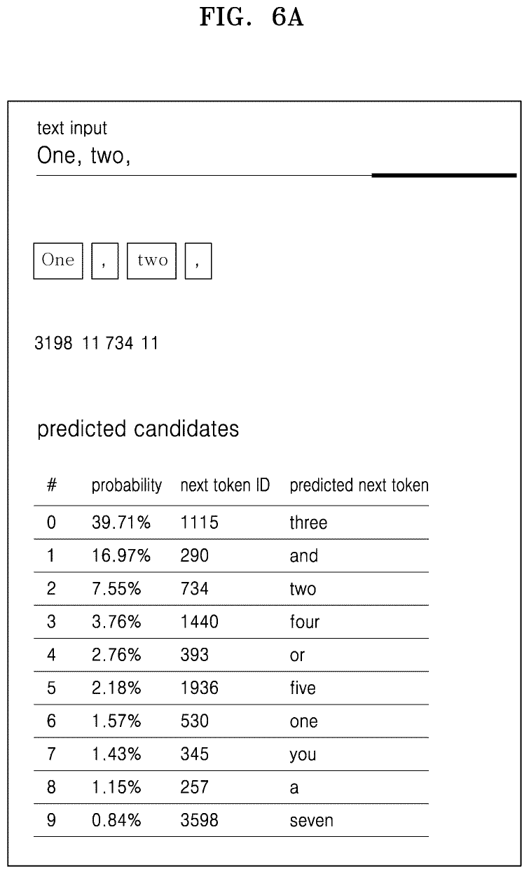

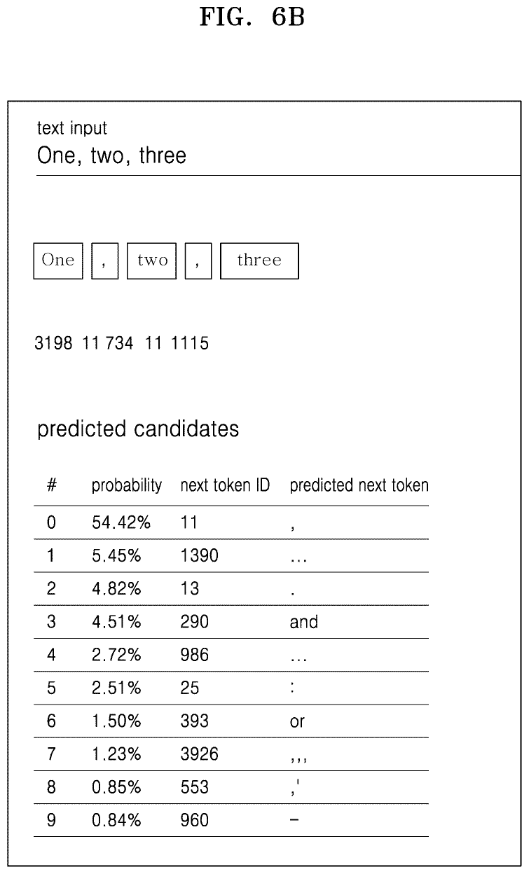

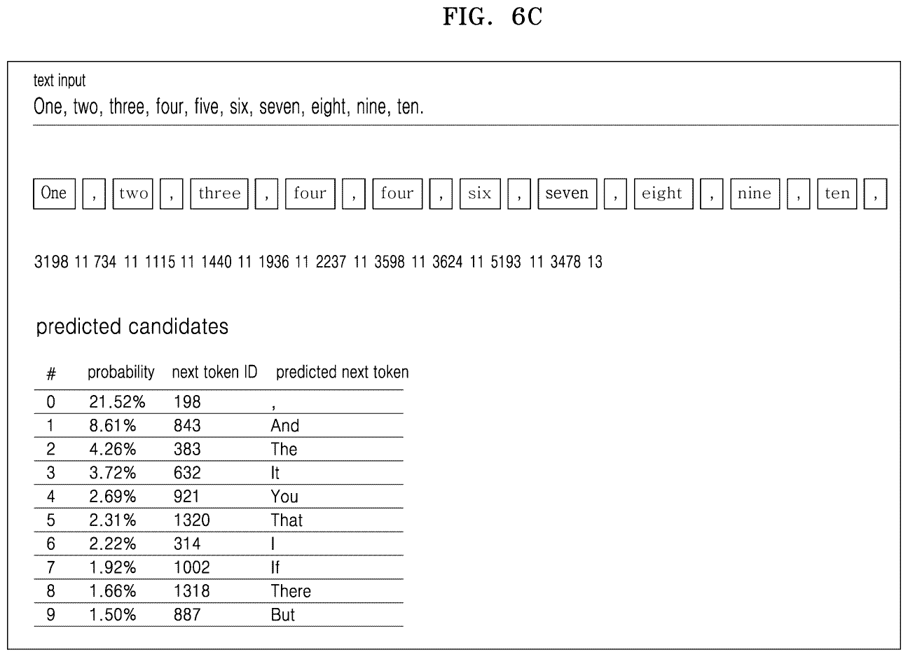

FIGS. 6A to 6C are diagrams illustrating an embodiment of deriving a predicted query based on a transmitted input query.

SLM (510) may repeatedly perform a process of predicting a next token following the last token of the input query based on the transmitted input query, and predict a next token of the input query including the predicted token until the next token is predicted as EOS (End Of Sentence). The EOS may be a token representing the end of a sentence.

For example, referring to FIG. 6A, if the input query transmitted to SLM (510) is “one, two,” SLM (510) may predict candidate tokens that may be next tokens. For example, as illustrated in FIG. 6A, the candidate tokens may be predicted as “three”, “and”, “two”, “four”, etc. The probabilities of the next token for the candidate tokens may be calculated. For example, referring to FIG. 6A, the probability of “three” as candidate token 0 may be calculated as 39.71%, the probability of “and” as candidate token 1 may be calculated as 16.97%, and the probability of “two” as candidate token 2 may be calculated as 7.55%. In this case, SLM (510) may predict “three”, which is the candidate token 0 with the highest probability, as the next token.

Thereafter, SLM (510) may predict a next token of the input query including the predicted token. For example, referring to FIG. 6B, SLM (510) may predict candidate tokens that may be the next token of the input query “one, two, three” including the predicted token “three” in the transmitted input query “one, two,”. For example, as illustrated in FIG. 6B, the candidate tokens may be predicted as “,”, “ . . . ”, “.”, “and”, etc. Also, for example, referring to FIG. 6B, the probability of candidate token 0, “,” may be calculated as 54.42%, the probability of candidate token 1, “ . . . ” may be calculated as 5.45%, and the probability of candidate token 2, “.”, may be calculated as 4.82%. In this case, SLM (510) may predict the candidate token 0 with the highest probability, “,”, as the next token.

Thereafter, SLM (510) may predict EOS as a next token of the input query including the predicted token. For example, referring to FIG. 6C, when the process of predicting the next token is repeatedly performed for the transmitted query “one, two,” and the query of “one, two, three, four, five, six, seven, eight, nine, ten.” is predicted, SLM (510) may predict candidate tokens that may become the next token. For example, as shown in FIG. 6C, the candidate tokens may be predicted as EOS, “And,” “The,” “It,” and so forth. For example, referring to FIG. 6C, the probability of candidate token 0, which is EOS, may be calculated as 21.52%, the probability of candidate token 1, which is “And,” may be calculated as 8.61%, and the probability of candidate token 2, which is “The,” may be calculated as 4.26%. In this case, SLM (510) may predict candidate token 0, which is EOS having the highest probability, as the next token. That is, since EOS, which is the token meaning the end of the sentence, is predicted as the next token, SLM (510) may terminate the process of predicting the next token, and may derive the predicted query “one, two, three, four, five, six, seven, eight, nine, ten.” as the predicted query.

Also, SLM (520) may derive a confidence score for the predicted query. For example, the confidence score may be derived based on the probabilities for the predicted tokens. For example, the confidence score may be derived as a weighted average or an arithmetic mean of the probabilities for the predicted tokens.

The input query entered by the user may be generally highly likely to exist within a predictable range, and therefore, the query prediction performance of SLM (520) may be high. It may be known that even in classical search engines, most queries have similar patterns, and query prediction (e.g., search term auto-completion) succeeds with a high probability. Therefore, the user's query may be predicted with a high probability by SLM (520), and accordingly, the increase in computation amount of the LLM inference task method using the predicted query may be minimized. Furthermore, if the LLM inference task method is specialized for a specific service, SLM (520) may be fine-tuned to fit the purpose of the specific service, and the prediction success probability may become higher.

The LLM control unit (530) may determine whether SLM (520) performs the next sequence of the LLM task based on the predicted query, based on the confidence score of the predicted query. For example, the LLM control unit (530) may determine whether SLM (520) derives the embedding vector of the predicted query based on the confidence score of the predicted query. For example, the LLM control unit (530) may determine whether to derive the embedding vector of the predicted query by comparing the confidence score of the predicted query with a specific value. For example, if the confidence score of the predicted query is greater than the specific value, the LLM control unit (530) may decide to derive the embedding vector of the predicted query, and if the confidence score of the predicted query is not greater than the specific value, the LLM control unit (530) may decide not to derive the embedding vector of the predicted query. That is, for example, if the confidence score of the predicted query is greater than the specific value, the LLM control unit (530) may transmit the predicted query to the embedding model (540), and if the confidence score of the predicted query is not greater than the specific value, the LLM control unit (530) may discard the predicted query. For example, the specific value may be preset.

When the predicted query is transmitted to the embedding model (540), the embedding model (540) may calculate the embedding vector of the predicted query. For example, the embedding model (540) may calculate the embedding vector of the predicted query, and may transmit the embedding vector of the predicted query to the LLM control unit (530).

Also, if an inference task is being performed based on a previous predicted query predicted by SLM (520) previously, the LLM control unit (530) may compare the embedding vector of the predicted query with an embedding vector of the previous predicted query to determine whether to perform the inference task based on the predicted query. It may be appropriate to stop the inference task being performed based on the previous predicted query and perform the inference task with the predicted query, if the predicted query has a semantic difference from the previous predicted query. That is, the efficiency of the inference task may be improved by maintaining the inference task being performed based on the previous predicted query when the predicted query does not have a semantic difference from the previous predicted query, and by stopping the inference task being performed based on the previous predicted query and performing the inference task with the predicted query when the predicted query has a semantic difference from the previous predicted query.

For example, the LLM control unit (530) may determine whether a difference between the embedding vector of the predicted query and the embedding vector of the previous predicted query is greater than a specific value. For example, if the difference between the embedding vector of the predicted query and the embedding vector of the previous predicted query is not greater than the specific value, the LLM control unit (530) may maintain the inference task being performed based on the previous predicted query, and if the difference between the embedding vector of the predicted query and the embedding vector of the previous predicted query is greater than the specific value, the LLM control unit (530) may stop the inference task being performed based on the previous predicted query, and may transmit the predicted query to the LLM (550).

Meanwhile, the LLM control unit (530) may include a cache memory. The cache memory may store information about the predicted query for which the inference task has been performed. For example, the cache memory may store information about the predicted query for which the inference task is currently being performed and information about the predicted query for which the inference task was previously performed. Here, the information about the predicted query for which the inference task has been performed may be denoted as inference task information. Also, the information about the predicted query for which the inference task is currently being performed may be denoted as latest inference task information. That is, the cache memory may store the latest inference task information being performed and the previously performed inference task information.

The inference task information may include the predicted query of the inference task, the embedding vector of the predicted query, the answer of the inference task, and/or a KV (Key-Value) matrix of the inference task. The answer may be a query derived by the inference task, and the KV matrix may be a KV matrix that was being used for the inference task.

For example, the inference task information stored in the cache memory may be as shown in the following table.

TABLE 1

| Embedding vector | Answer |
|---|---|
| [ . . . ] | [ . . . ] |
| [ . . . ] | [ . . . ] |
| [1, 0, 2, 0] | The cheetah can reach speeds of |
| [0, 2, 0, 1] | |

Referring to the Table 1, the row may represent the inference task information. That is, each of rows of Table 1 may represent the inference task information for each of inference tasks. For example, the inference task information may include an embedding vector of a predicted query and the answer of the inference task for the predicted query.

Also, a flag that represents the latest inference task information among the inference task information stored in the cache memory may be used. For example, a 1-bit flag may represent the latest inference task information among inference task information stored in the cache memory. The latest inference task information may represent information about the predicted query for which the inference task was performed at the very last, that is, most recently, among the information about the query stored in the cache memory. The flag may be represented as the latest inference task flag.

For example, the inference task information stored in the cache memory and the latest inference task flag may be as shown in the following table.

TABLE 2

| Embedding | | |
|---|---|---|
| vector | Answer | Latest |
| [ . . . ] | [ . . . ] | |
| [ . . . ] | [ . . . ] | |
| [1, 0, 2, 0] | The cheetah can reach speeds of | |
| [0, 2, 0, 1] | | V |

Referring to the Table 2, the row may represent the inference task information, and the latest inference task information among the inference task information stored in the cache memory may be marked with the latest inference task flag that represents the latest inference task information.

The LLM control unit (530) may compare the embedding vector of the predicted query with embedding vectors of the inference task information stored in the cache memory to determine whether to perform the inference task based on the predicted query.

For example, if a difference between the embedding vector of the predicted query and the embedding vectors of the inference task information in the cache memory is smaller than a specific value, the LLM control unit (530) may decide not to perform the inference task based on the predicted query, and may not transmit the predicted query to the LLM (550). In this case, the predicted query may be discarded. The LLM (550) may perform the inference task that was being performed previously to generate the answer. That is, the LLM (550) may perform the inference task based on the query transmitted most recently to generate the answer.

Also, for example, if the difference between the embedding vector of the predicted query and the embedding vectors of the inference task information in the cache memory is greater than or equal to a specific value, the LLM control unit (530) may decide to stop the inference task for the query transmitted most recently that is being performed and perform the inference task based on the predicted query, and may transmit the predicted query to the LLM (550). The LLM (550) may perform the inference task based on the predicted query to generate the answer.

Alternatively, for example, if the difference between the embedding vector of the predicted query and the embedding vector of the latest inference task information in the cache memory is greater than a specific value, the LLM control unit (530) may determine whether inference task information including an embedding vector whose difference from the embedding vector of the predicted query is smaller than or equal to a specific value exists among the inference task information stored in the cache memory, and if inference task information including an embedding vector whose difference from the embedding vector of the predicted query is smaller than or equal to a specific value exists, the LLM control unit (530) may load an answer of the inference task information including the embedding vector whose difference from the embedding vector of the predicted query is smaller than or equal to the specific value, and the LLM (550) may perform an inference task based on a predicted query of the loaded inference task information to generate an answer following the loaded answer. The LLM (550) may perform the inference task for the loaded predicted query using a KV (Key-Value) matrix of the loaded inference task information to generate the answer. Therefore, the LLM (550) may generate the answer using the inference task information of the previously performed inference task, and thereby may minimize a penalty of the inference task using the predicted full query and improve the efficiency.

Meanwhile, the LLM control unit (530) may perform the comparison between the embedding vector of the predicted query and the embedding vector of the latest inference task information in the cache memory and the comparison with the embedding vectors of the inference task information other than the latest inference task information at once. For example, the latest inference task information and the previously performed inference task information may be stored as a matrix in the cache memory, and the differences between the embedding vector of the predicted query and all the embedding vectors of the cache memory may be calculated in parallel.

For example, the LLM control unit (530) may calculate the differences between the embedding vector of the predicted query and the embedding vectors of the inference task information stored in the cache memory.

Thereafter, for example, if an embedding vector of the smallest difference among the differences is an embedding vector of the latest inference task information, and the smallest difference is smaller than a specific value, the LLM control unit (530) may decide not to perform the inference task based on the predicted query, and may decide to perform an existing inference task being performed based on the predicted query of the latest inference task information.

Alternatively, for example, if an embedding vector of the smallest difference among the differences is an embedding vector of the latest inference task information, and the smallest difference is greater than or equal to a specific value, the LLM control unit (530) may decide to stop an existing inference task being performed based on the predicted query of the latest inference task information and perform an inference task based on the predicted query.

Alternatively, for example, if an embedding vector of the smallest difference among the differences is not an embedding vector of the latest inference task information, and the smallest difference is greater than or equal to a specific value, the LLM control unit (530) may decide to stop an existing inference task being performed based on the predicted query of the latest inference task information and perform an inference task based on the predicted query.

Meanwhile, for example, the specific value for determining whether to perform the inference task based on the predicted query may be set larger as the user's input query is shorter. That is, for example, the specific value may be set inversely proportional to a length of the input query or a number of tokens of the input query.

Meanwhile, when the LLM operation is additionally performed, the cost for the LLM operation may increase. Therefore, a method for reducing the cost of the LLM operation may be applied. For example, Adaptive resource allocation may be applied. For example, the LLM may allocate resources for the answer generation operation, that is, the operation of the inference task, based on the length of the user's input query. For example, the LLM may allocate resources for the operation of the inference task in proportion to the length of the input query or the number of tokens of the input query. As the length of the input query is shorter, the probability that SLM's query prediction may fail may be higher, and accordingly, by maintaining a smaller amount of computational resources as the length of the input query is shorter, the effect of reducing sunk costs may be generated. Furthermore, since the operation starts in advance, even if slowly, at the initial stage of a user request where the length of the input query is short, the effect of reducing latency may be obtained.

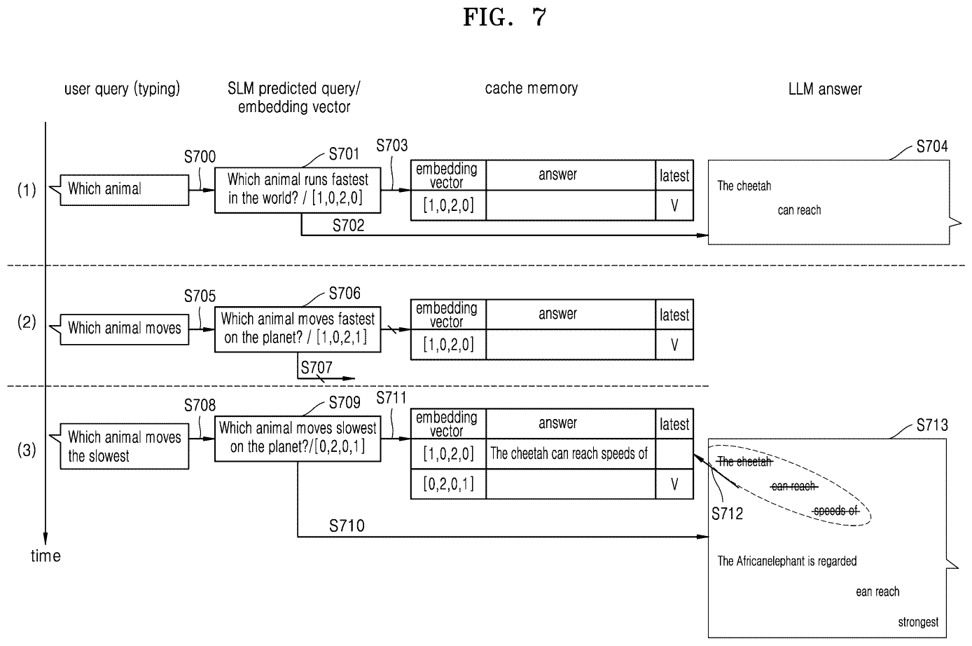

FIG. 7 is a flowchart for explaining in detail an inference task method of an LLM inference task system according to an embodiment of the present disclosure.

The tokenizer may determine whether an update of the input query occurs, and if the input query is updated compared to the previously transmitted input query, the tokenizer may tokenize the input query and transmit it to the SLM (S700). For example, referring to FIG. 7, the user's input query may be “Which animal.” Since there is no input query previously transmitted to the SLM, the tokenizer may tokenize the input query “Which animal” and transmit it to the SLM.

The SLM may derive a predicted query based on the user's input query (S701). The input query may be a query tokenized by the tokenizer described above, and the predicted query may be a complete sentence predicted based on the input query.

For example, referring to FIG. 7, the user's input query may be “Which animal.” That is, the input query may be a word or words that are not a complete sentence.

The SLM may derive the predicted query “Which animal runs fastest in the world?” based on the input query “Which animal.” Also, the embedding model may derive an embedding vector of the predicted query. The embedding model may derive the embedding vector of the predicted query, and may transmit the embedding vector to the SLM.

The LLM controller may determine whether to perform an inference task for the predicted query (S702). For example, if the LLM is not performing an inference task, the LLM controller may determine to perform the inference task for the predicted query, and may transmit the predicted query to the LLM. That is, the LLM controller may request the LLM to perform the inference task for the predicted query.

Referring to FIG. 7, there is no predicted query input to the LLM before the predicted query “Which animal runs fastest in the world?” is derived, and thus the LLM may not be performing the inference task. Accordingly, the LLM controller may determine to perform the inference task for the predicted query “Which animal runs fastest in the world?”, and may transmit the predicted query “Which animal runs fastest in the world?” to the LLM.

Also, the LLM controller may store inference task information for the predicted query in the cache memory (S703). For example, the LLM controller may store the predicted query and the embedding vector of the predicted query as the inference task information of the predicted query in the cache memory. Referring to FIG. 7, the embedding vector for the predicted query “Which animal runs fastest in the world?” may be derived as [1,0,2,0]. The LLM controller may store the predicted query and the embedding vector of the predicted query as the inference task information of the predicted query in the cache memory. Also, an answer generated by the inference task for the predicted query and/or a KV matrix of the inference task may be stored as the inference task information. The inference task information of the predicted query may include the predicted query, the embedding vector, the answer of the inference task, and/or the KV matrix of the inference task. Also, the LLM controller may mark latest inference task information, which is information about the most recent inference task among the inference task information of the predicted query, with a flag in the cache memory. That is, the LLM controller may mark the latest inference task information, which is the information about the inference task being performed among the inference task information of the predicted query, with a flag in the cache memory. The flag may represent the latest inference task information. Here, the latest inference task information may be inference task information for an inference task being performed. The flag may be represented as the latest inference task flag. Referring to FIG. 7, the latest inference task flag representing that the inference task information of the predicted query is the latest inference task information may be marked.

Also, the LLM may perform the inference task for the predicted query to generate an answer (S704). Referring to FIG. 7, the LLM may perform the inference task for the predicted query “Which animal runs fastest in the world?” to generate an answer. The LLM may sequentially generate words of the answer. For example, the LLM may generate “The cheetah can reach” as the answer for the predicted query “Which animal runs fastest in the world?”, and may sequentially generate words following the “The cheetah can reach” to generate the answer of the completed sentence.

Thereafter, the tokenizer may determine whether an update of the input query occurs, and if the input query is updated compared to the previously transmitted input query, the tokenizer may tokenize the input query and transmit it to the SLM (S705). For example, referring to FIG. 7, the user may further input the word “moves.” The tokenizer may determine that the input query is updated from the input query “Which animal” previously transmitted to the SLM to “Which animal moves,” and may tokenize the updated input query and transmit it to the SLM. The tokenizer may determine whether the update of the input query occurs in token units. Through this, the SLM calls may be minimized.

The SLM may derive a predicted query based on the updated input query (S706). For example, the SLM may derive a predicted query “Which animal moves fastest on the planet?” based on the updated input query “Which animal moves.” Also, the embedding model may derive an embedding vector of the predicted query. The embedding model may derive the embedding vector of the predicted query, and may transmit the embedding vector to the SLM. For example, the embedding model may derive the embedding vector [1,0,2,1] of the predicted query “Which animal moves fastest on the planet?” of the updated input query.

The LLM controller may determine whether to perform an inference task for the predicted query (S707). For example, if the LLM is performing an inference task, the LLM controller may determine whether to perform an inference task for the predicted query based on the embedding vector of the predicted query.

For example, the LLM controller may compare the embedding vector of the predicted query with embedding vectors of inference task information stored in the cache memory, and if a difference between the embedding vector of the predicted query and the embedding vectors of the inference task information is greater than a specific value (that is, if there is no embedding vector of inference task information whose difference from the embedding vector of the predicted query is smaller than or equal to a specific value), the LLM controller may determine to perform the inference task for the predicted query, and may transmit the predicted query to the LLM. That is, if the difference between the embedding vector of the predicted query and the embedding vectors of the inference task information is greater than a specific value (that is, if there is no embedding vector of the inference task information whose difference from the embedding vector of the predicted query is smaller than or equal to a specific value), the LLM controller may request the LLM to perform the inference task for the predicted query of the updated input query. In this case, the LLM controller may store inference task information of the updated predicted query in the cache memory.

Alternatively, for example, the LLM controller may compare the embedding vector of the predicted query with the embedding vectors of the inference task information stored in the cache memory, and if an embedding vector of inference task information whose difference from the embedding vector of the predicted query is smaller than or equal to a specific value exists, and an embedding vector of the smallest difference is an embedding vector of latest inference task information, the LLM controller may determine not to perform the inference task for the predicted query, and may determine to perform the inference task that is being performed.

Alternatively, for example, the LLM controller may compare the embedding vector of the predicted query with the embedding vectors of the inference task information stored in the cache memory, and if an embedding vector of inference task information whose difference from the embedding vector of the predicted query is smaller than or equal to a specific value exists, and an embedding vector of the smallest difference is not an embedding vector of latest inference task information, the LLM controller may determine to perform an inference task for a predicted query of the embedding vector of the smallest difference, and may transmit inference task information of the embedding vector of the smallest difference to the LLM.

Referring to FIG. 7, since only the latest inference task information is stored in the cache memory, the LLM controller may compare the embedding vector [1,0,2,1] of the predicted query “Which animal moves fastest on the planet?” with the embedding vector [1,0,2,0] of the latest inference task information stored in the cache memory. Since a difference between the embedding vector [1,0,2,1] of the predicted query and the embedding vector [1,0,2,0] of the latest inference task information is smaller than or equal to a specific value, and an embedding vector of the smallest difference is the embedding vector of the latest inference task information, the LLM controller may determine not to perform the inference task for the predicted query, and may determine to perform the inference task that is being performed, that is, the latest inference task. In this case, the LLM may perform the latest inference task that is being performed. That is, the LLM may perform the inference task for the previously transmitted predicted query “Which animal runs fastest in the world?” to generate an answer. Also, the predicted query “Which animal moves fastest on the planet?” of the updated input query may be discarded.

Also, the tokenizer may determine whether an update of the input query occurs, and if the input query is updated compared to the previously transmitted input query, the tokenizer may tokenize the input query and transmit it to the SLM (S708). For example, referring to FIG. 7, the user may further input a word “slowest.” The tokenizer may determine that the input query is updated from the input query “Which animal moves” previously transmitted to the SLM to “Which animal moves the slowest,” and may tokenize the updated input query and transmit it to the SLM. The tokenizer may determine whether the update of the input query occurs in token units. Through this, the SLM calls may be minimized.

The SLM may derive a predicted query based on the updated input query (S709). For example, the SLM may derive a predicted query “Which animal moves the slowest on the planet?” based on the updated input query “Which animal moves the slowest.” Also, the embedding model may derive an embedding vector of the predicted query. The embedding model may derive the embedding vector of the predicted query, and may transmit the embedding vector to the SLM. For example, the embedding model may derive the embedding vector [0,2,0,1] of the predicted query “Which animal moves the slowest on the planet?” of the updated input query.

The LLM controller may determine whether to perform an inference task for the predicted query (S710). For example, if the LLM is performing the inference task, the LLM controller may determine whether to perform the inference task for the predicted query based on the embedding vector of the predicted query.

Referring to FIG. 7, since only the latest inference task information is stored in the cache memory, the LLM controller may compare the embedding vector [0,2,0,1] of the predicted query “Which animal moves the slowest on the planet?” with the embedding vector [1,0,2,0] of the latest inference task information stored in the cache memory. Since a difference between the embedding vector [0,2,0,1] of the predicted query and the embedding vector [1,0,2,0] of the latest inference task information is greater than a specific value, the LLM controller may determine to perform the inference task for the predicted query, and may transmit the predicted query “Which animal moves the slowest on the planet?” to the LLM.

Also, the LLM controller may store inference task information of the updated predicted query in the cache memory (S711). That is, the LLM controller may store inference task information of the predicted query “Which animal moves the slowest on the planet?” in the cache memory. For example, the LLM controller may store the predicted query and the embedding vector of the predicted query “Which animal moves the slowest on the planet?” as the inference task information of the predicted query in the cache memory. Also, the LLM controller may mark the inference task information of the updated predicted query with a latest inference task flag. The latest inference task flag may represent that the inference task information of the updated predicted query is the latest inference task information.

Also, the LLM controller may store inference task information of the inference task that was being performed in the cache memory (S712). That is, the inference task information of the predicted query “Which animal runs the fastest in the world?” that was being performed may be stored in the cache memory. For example, the LLM controller may store a generated answer and a KV matrix of the inference task of the predicted query “Which animal runs the fastest in the world?” that was being performed as the inference task information of the predicted query in the cache memory.

The LLM may perform an inference task for the transmitted predicted query to generate an answer (S713). Referring to FIG. 7, the LLM may perform the inference task for the transmitted predicted query “Which animal moves the slowest on the planet?” to generate an answer. The LLM may perform the inference task for the predicted query “Which animal moves the slowest on the planet?” to generate an answer. The LLM may sequentially generate words of the answer. For example, the LLM may generate “The African elephant is regarded as the strongest” as the answer for the predicted query “Which animal moves the slowest on the planet?”, and may sequentially generate words following the “The African elephant is regarded as the strongest” to generate the answer of the completed sentence.

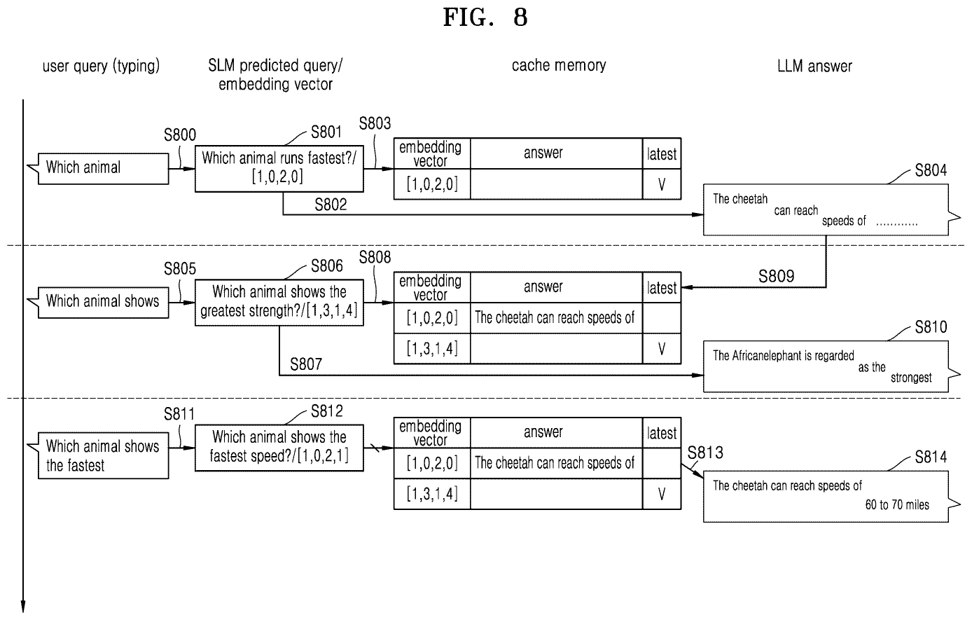

FIG. 8 is a flowchart for explaining in detail an inference task method of an LLM inference task system according to an embodiment of the present disclosure.

FIG. 8 may represent an embodiment of the present disclosure where an inference task is performed when a difference between an embedding vector of a predicted query and embedding vectors of inference task information stored in the cache memory is smaller than or equal to a specific value.

The tokenizer may determine whether an update of an input query occurs, and if the input query is updated compared to a previously transmitted input query, the tokenizer may tokenize the input query and transmit it to the SLM (S800). For example, referring to FIG. 8, the user's input query may be “Which animal.” Since there is no input query previously transmitted to the SLM, the tokenizer may tokenize the input query “Which animal” and transmit it to the SLM.

The SLM may derive a predicted query based on the user's input query (S801). The input query may be a query tokenized by the tokenizer described above, and the predicted query may be a sentence predicted based on the input query.

For example, referring to FIG. 8, the user's input query may be “Which animal.” That is, the input query may be a word or words that are not a complete sentence.

The SLM may derive the predicted query “Which animal runs fastest?” based on the input query “Which animal.” Also, the embedding model may derive an embedding vector of the predicted query. The embedding model may derive the embedding vector of the predicted query, and may transmit the embedding vector to the SLM.

The LLM controller may determine whether to perform an inference task for the predicted query (S802). For example, if the LLM is not performing an inference task, the LLM controller may determine to perform the inference task for the predicted query, and may transmit the predicted query to the LLM. That is, the LLM controller may request the LLM to perform the inference task for the predicted query.

Referring to FIG. 8, there is no query input to the LLM before the predicted query “Which animal runs fastest?” is derived, and thus the LLM may not be performing the inference task. Accordingly, the LLM controller may determine to perform the inference task for the predicted query “Which animal runs fastest?”, and may transmit the predicted query “Which animal runs fastest?” to the LLM.

Also, the LLM controller may store inference task information for the predicted query in the cache memory (S803). For example, the LLM controller may store the predicted query and the embedding vector of the predicted query as the inference task information of the predicted query in the cache memory. Referring to FIG. 8, the embedding vector for the predicted query “Which animal runs fastest?” may be derived as [1,0,2,0]. The LLM controller may store the predicted query and the embedding vector of the predicted query as the inference task information of the predicted query in the cache memory. Also, the LLM controller may mark inference task information, which is information about the most recent inference task among the inference task information of the predicted query, with a flag in the cache memory. That is, the LLM controller may mark the inference task information, which is the information about the inference task being performed among the inference task information of the predicted query, with a flag in the cache memory. The flag may represent the latest inference task information. Here, the latest inference task information may be the inference task information for the inference task being performed. The flag may be represented as the latest inference task flag. Referring to FIG. 8, the latest inference task flag representing that the inference task information of the predicted query is the latest inference task information may be marked.

Also, the LLM may perform the inference task for the predicted query to generate an answer (S804). Referring to FIG. 8, the LLM may perform the inference task for the predicted query “Which animal runs fastest?” to generate an answer. The LLM may sequentially generate words of the answer. For example, the LLM may generate “The cheetah can reach speeds of” as the answer for the predicted query “Which animal runs fastest?”, and may sequentially generate words following the “The cheetah can reach speeds of” to generate the answer of the completed sentence.

Thereafter, the tokenizer may determine whether an update of the input query occurs, and if the input query is updated compared to the previously transmitted input query, the tokenizer may tokenize the input query and transmit it to the SLM (S805). For example, referring to FIG. 8, the user may further input a word “shows.” The tokenizer may determine that the input query is updated from the input query “Which animal” previously transmitted to the SLM to “Which animal shows,” and may tokenize the updated input query and transmit it to the SLM. The tokenizer may determine whether the update of the input query occurs in token units. Through this, the SLM calls may be minimized.

The SLM may derive a predicted query based on the updated input query (S806). For example, the SLM may derive the predicted query “Which animal shows the greatest strength?” based on the updated input query “Which animal shows.” Also, the embedding model may derive an embedding vector of the predicted query. The embedding model may derive the embedding vector of the predicted query, and may transmit the embedding vector to the SLM. For example, the embedding model may derive the embedding vector [1,3,1,4] of the predicted query “Which animal shows the greatest strength?” of the updated input query.

The LLM controller may determine whether to perform an inference task for the predicted query (S807). For example, if the LLM is performing the inference task, the LLM controller may determine whether to perform the inference task for the predicted query based on the embedding vector of the predicted query.

Referring to FIG. 8, since only the latest inference task information is stored in the cache memory, the LLM controller may compare the embedding vector [1,3,1,4] of the predicted query “Which animal shows the greatest strength?” with the embedding vector [1,0,2,0] of the latest inference task information stored in the cache memory. Since a difference between the embedding vector [1,3,1,4] of the predicted query and the embedding vector [1,0,2,0] of the latest inference task information is greater than a specific value, the LLM controller may determine to perform the inference task for the predicted query, and may transmit the predicted query “Which animal shows the greatest strength?” to the LLM.

Also, the LLM controller may store inference task information of the updated predicted query in the cache memory (S808). That is, the LLM controller may store the inference task information of the predicted query “Which animal shows the greatest strength?” in the cache memory. For example, the LLM controller may store the predicted query and the embedding vector of the predicted query as the inference task information of the predicted query in the cache memory. Also, the LLM controller may mark the inference task information of the updated predicted query with the latest inference task flag. The latest inference task flag may represent that the inference task information of the updated predicted query is the latest inference task information.

Also, the LLM controller may store inference task information of the inference task that was being performed in the cache memory (S809). That is, the inference task information of the predicted query “Which animal runs the fastest?” that was being performed may be stored in the cache memory. For example, the LLM controller may store a generated answer and a KV matrix of the inference task of the predicted query “Which animal runs the fastest?” that was being performed as the inference task information of the predicted query in the cache memory.

Also, the LLM may perform the inference task for the predicted query to generate an answer (S810). Referring to FIG. 8, the LLM may perform the inference task for the predicted query “Which animal shows the greatest strength?” to generate an answer. The LLM may sequentially generate words of the answer. For example, the LLM may generate “The African elephant is regarded as the strongest” as the answer for the predicted query “Which animal shows the greatest strength?”, and may sequentially generate words following the “The African elephant is regarded as the strongest” to generate the answer of the completed sentence.

Also, the tokenizer may determine whether an update of an input query occurs, and if the input query is updated compared to the previously transmitted input query, the tokenizer may tokenize the input query and transmit it to the SLM (S811). For example, referring to FIG. 8, the user may further input a word “fastest.” The tokenizer may determine that the input query is updated from the input query “Which animal shows” previously transmitted to the SLM to “Which animal shows the fastest,” and may tokenize the updated input query and transmit it to the SLM. The tokenizer may determine whether the update of the input query occurs in token units. Through this, the SLM calls may be minimized.

The SLM may derive a predicted query based on the updated input query (S812). For example, the SLM may derive the predicted query “Which animal shows the fastest speed?” based on the updated input query “Which animal shows the fastest.” Also, the embedding model may derive an embedding vector of the predicted query. The embedding model may derive the embedding vector of the predicted query, and may transmit the embedding vector to the SLM. For example, the embedding model may derive the embedding vector [1,0,2,1] of the predicted query “Which animal shows the fastest speed?” of the updated input query.

The LLM controller may determine whether to perform an inference task for the predicted query (S813). For example, if the LLM is performing the inference task, the LLM controller may determine whether to perform the inference task for the predicted query based on the embedding vector of the predicted query. For example, if the LLM is performing the inference task, the LLM controller may determine whether to perform the inference task for the predicted query based on the embedding vector of the predicted query and embedding vectors of inference task information stored in the cache memory.

For example, if an embedding vector of inference task information whose difference from the embedding vector of the predicted query is smaller than or equal to a specific value exists, and an embedding vector of the smallest difference is not an embedding vector of the latest inference task information, the LLM controller may determine to perform an inference task for a predicted query of the embedding vector of the smallest difference, and may transmit the inference task information of the embedding vector of the smallest difference to the LLM.

Referring to FIG. 8, the LLM controller may compare the embedding vector [1,0,2,1] of the predicted query “Which animal shows the fastest speed?” with embedding vectors of the inference task information stored in the cache memory. For example, the LLM controller may compare the embedding vector [1,0,2,1] of the predicted query “Which animal shows the fastest speed?” with the embedding vector [1,0,2,0] of the inference task information and the embedding vector [1,3,1,4] of the latest inference task information. In this case, the difference between the embedding vector [1,0,2,1] of the predicted query and the embedding vector [1,0,2,0] of the inference task information may be smaller than or equal to a specific value, and the embedding vector of the smallest difference may be the embedding vector [1,0,2,0] of the inference task information. Therefore, the LLM controller may determine to perform the inference task for the predicted query of the embedding vector [1,0,2,0] of the smallest difference, and may transmit the inference task information of the embedding vector of the smallest difference to the LLM.

The LLM may re-perform the inference task for the predicted query of the transmitted inference task information to generate an answer (S814). Referring to FIG. 8, the LLM may load an answer of the transmitted inference task information, and may perform the inference task for the predicted query “Which animal runs fastest?” of the transmitted inference task information to sequentially generate words following the answer to generate an answer of a completed sentence. For example, the LLM may load the answer “The cheetah can reach speeds of” of the transmitted inference task information, and may perform the inference task for the predicted query to generate “60 to 70 miles” following the answer.

Meanwhile, the LLM inference task system proposed in the present disclosure may be implemented with various device configurations.

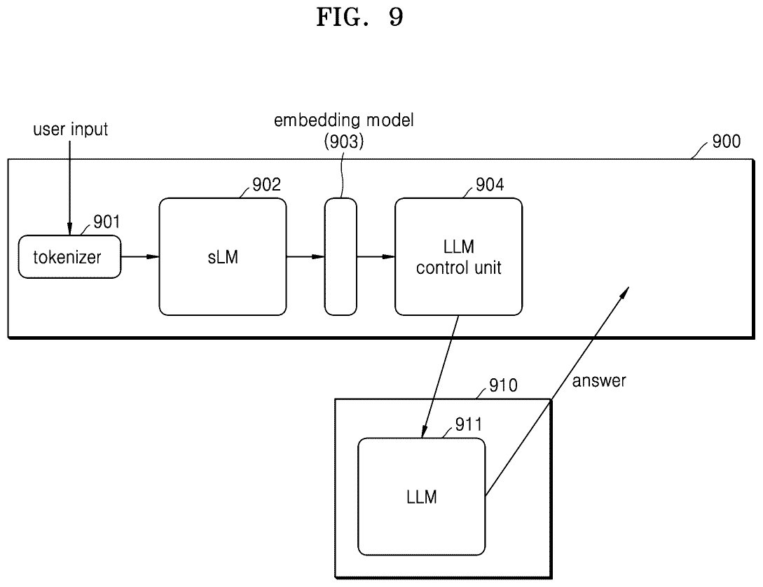

FIG. 9 is a diagram illustrating an embodiment of a device configuration that implements the LLM inference task system of the present disclosure.

Referring to FIG. 9, the LLM inference task system may be configured with a host and an LLM processor, the host may include a tokenizer, an SLM, an embedding model and/or an LLM control unit, and the LLM processor may include an LLM. The host may include general purpose CPUs, and the LLM processor may be an LLM-dedicated accelerator.

Referring to FIG. 9, the tokenizer (901), the SLM (902), the embedding model (903) and/or the LLM control unit (904) may be implemented by the host (900), and the LLM processor (910) may include the LLM (911). The amount of computation for the operation of the SLM (902) and the operation of the embedding model (903) may be small, and in this case, the operation of the SLM (902) and the operation of the embedding model (903) may be possible by the host (900). When the LLM inference task system is implemented as shown in FIG. 9, it may be used in an existing system without the introduction of additional hardware for the LLM inference task system, and thus the compatibility in the existing system may be high.

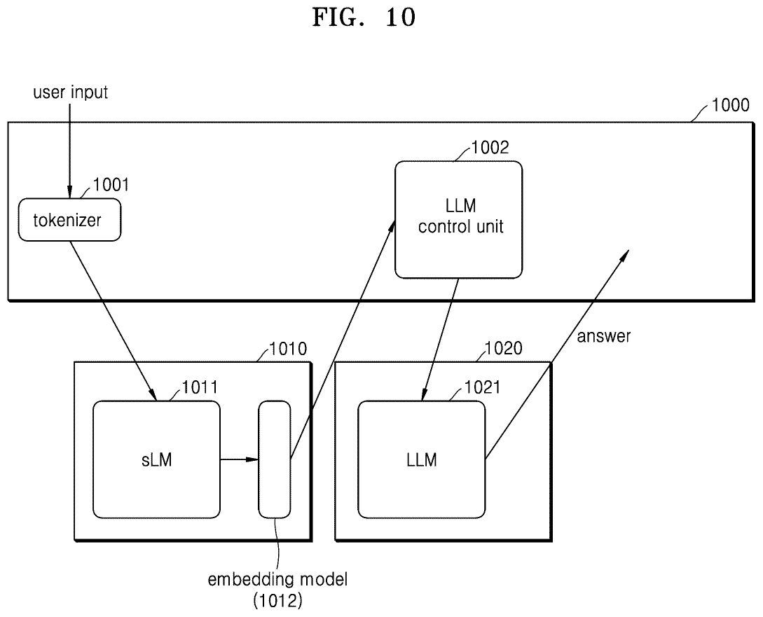

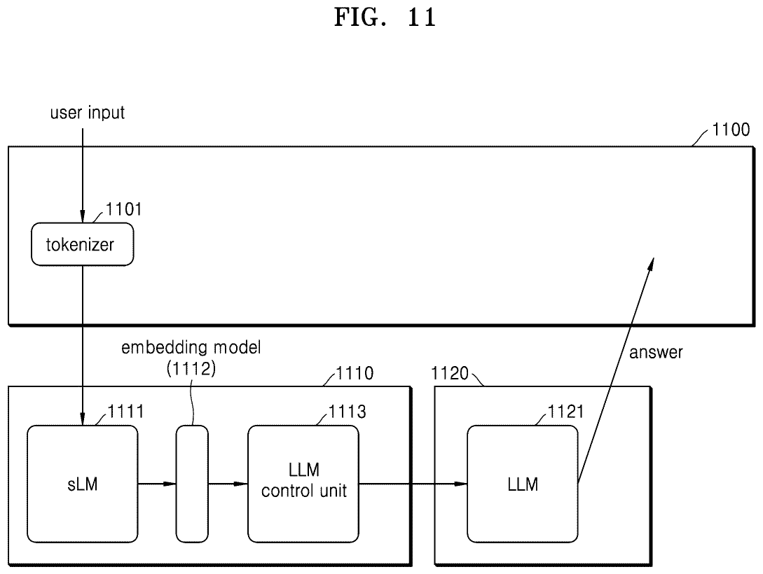

FIG. 10 is a diagram illustrating another embodiment of a device configuration that implements the LLM inference task system of the present disclosure.

Referring to FIG. 10, the LLM inference task system may be configured with a host (1000), an SLM processor (1010) and an LLM processor (1020), the host (1000) may include a tokenizer (1001) and/or an LLM control unit (1002), the SLM processor (1010) may include an SLM (1011) and/or an embedding model (1012), and the LLM processor (1020) may include an LLM (1021). The host (1000) may include general purpose CPUs, the SLM processor (1010) may be an SLM-dedicated accelerator, and the LLM processor (1020) may be an LLM-dedicated accelerator.

Referring to FIG. 10, the tokenizer (1001) and/or the LLM control unit (1002) may be implemented by the host (1000), and the operation of the SLM (1011) and/or the operation of the embedding model (1012) may be processed by the SLM processor (1010). The amount of computation of the SLM (1011), the amount of computation of the LLM (1021), and the amount of computation of the embedding model (1012) may be large, and accordingly, the operation of the SLM (1011), the operation of the embedding model (1012), and the operation of the LLM (1021) may be performed using a dedicated accelerator. Also, the tokenizer (1001) with a small amount of computation may be performed by the host (1000), and the processing of the LLM control unit (1002) requiring high flexibility may be performed by the host (1000). Through this, the SLM (1011), the embedding model (1012), and the LLM (1021) with a high amount of computation may be processed using a dedicated accelerator, and the computational efficiency of the LLM inference task system may be improved.

FIG. 11 is a diagram illustrating another embodiment of a device configuration that implements the LLM inference task system of the present disclosure.

Referring to FIG. 11, the LLM inference task system may be configured with a host (1100), an SLM processor (1110), and an LLM processor (1120), the host (1100) may include a tokenizer (1101), the SLM processor (1110) may include an SLM (1111), an embedding model (1112) and/or an LLM control unit (1113), and the LLM processor (1120) may include an LLM (1121). The host (1100) may include general purpose CPUs, the SLM processor (1110) may be an SLM-dedicated accelerator, and the LLM processor (1120) may be an LLM-dedicated accelerator.

Through this, the processing of the LLM control unit (1113) may be processed in the SLM accelerator by replacing it with an operation capable of acceleration, and a large amount of queries may be moved without host communication through P2P communication (e.g., PCIe, UCIe, or Ethernet, etc.) between the accelerators. Therefore, communication speed may be increased by minimizing the communication between the accelerator and the host (1100), and the computational efficiency of the LLM inference task system may be improved by minimizing the burden on the host (1100).

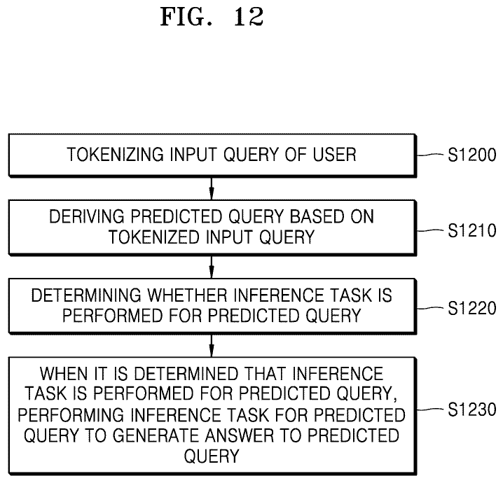

FIG. 12 is a flowchart explaining in detail an inference task method of an LLM inference task system according to an embodiment of the present disclosure.

The tokenizer tokenizes an input query of a user (S1200). The tokenizer may tokenize the user's input query. The tokenizer may tokenize the user's input query, and may transmit the tokenized input query to the SLM.

Also, the tokenizer may detect whether a new token, which is not unknown, is added whenever the user adds a character to the query, and may tokenize the input query every time a new token is input. That is, whether an update of the input query occurs may be determined in token units.

If the input query is updated compared to the previously transmitted input query, the tokenizer may tokenize the updated input query, and may transmit the tokenized input query to the SLM. That is, for example, the tokenizer may determine whether the update of the input query occurs, and if the input query is updated, the tokenizer may tokenize the updated input query, and may transmit the tokenized input query to the SLM. Whether the update of the input query occurs may be determined in token units.

The SLM derives a predicted query based on the tokenized input query (S1210). The SLM may derive the predicted query based on the tokenized input query. Here, for example, the predicted query may be a sentence predicted based on the input query. The input query may not be a complete sentence, and the predicted query may be a complete sentence predicted based on the input query. The predicted query may be represented as a full query.

The SLM may derive a confidence score of the predicted query. For example, the confidence score may be derived based on a probability for a predicted token of the predicted query. The predicted token may be a token in the predicted query excluding the input query. For example, the confidence score may be derived as a weighted average or an arithmetic mean of the probability for the predicted token.

The LLM control unit determines whether to perform an inference task for the predicted query (S1220). For example, if an inference task is not being performed, the LLM control unit may determine that the inference task for the predicted query is performed.

Meanwhile, for example, an embedding model may derive an embedding vector of the predicted query. Alternatively, for example, if the confidence score of the predicted query is greater than a specific value, the embedding model may derive the embedding vector of the predicted query.

For example, if an inference task is being performed, the LLM control unit may determine whether to perform the inference task for the predicted query based on the embedding vector of the predicted query.

For example, the LLM control unit may compare the embedding vector of the predicted query with embedding vectors of inference task information stored in a cache memory. The cache memory may store inference task information for a performed inference task. The inference task information stored in the cache memory may include latest inference task information being performed and/or previously performed inference task information. Also, for example, the latest inference task information in the inference task information stored in the cache memory may be marked with a latest inference task flag representing the latest inference task information. The latest inference task flag may represent inference task information of an inference task being performed. The inference task information may include a predicted query, an embedding vector, an answer, and/or a KV matrix for an inference task. The answer included in the inference task information may represent an answer generated in an inference task of the inference task information, and the KV matrix included in the inference task information may represent a KV matrix used in the inference task of the inference task information.

For example, if an embedding vector of inference task information whose difference from the embedding vector of the predicted query is smaller than or equal to a specific value does not exist, the LLM controller may determine that the inference task for the predicted query is performed. In this case, the LLM controller may request the LLM to perform the inference task for the predicted query.

Alternatively, for example, if an embedding vector of inference task information whose difference from the embedding vector of the predicted query is smaller than or equal to a specific value exists, and an embedding vector of the smallest difference is an embedding vector of latest inference task information, the LLM controller may determine that the inference task for the predicted query is not performed. In this case, an inference task being performed may continue to be performed.

Alternatively, for example, if an embedding vector of inference task information whose difference from the embedding vector of the predicted query is smaller than or equal to a specific value exists, and an embedding vector of the smallest difference is an embedding vector of a specific inference task information which is not the latest inference task information, the LLM controller may determine that the inference task for the predicted query is not performed, and may determine that an inference task of the specific inference task information is performed. That is, for example, if an embedding vector of inference task information whose difference from the embedding vector of the predicted query is smaller than or equal to a specific value exists, and an embedding vector of the smallest difference is an embedding vector of a specific inference task information which is not the latest inference task information, the LLM controller may determine that an inference task of the specific inference task information is performed. In this case, the LLM controller may request the LLM to perform the inference task of the specific inference task information.

Here, for example, the specific value may be preset. Alternatively, for example, the specific value may be set to be inversely proportional to a length of the input query or a number of tokens of the input query.

If it is determined that the inference task for the predicted query is performed, the LLM performs the inference task for the predicted query to generate an answer for the predicted query (S1230). The LLM may perform the inference task for the predicted query to generate an answer for the predicted query.

Also, if it is determined that the inference task for the predicted query is performed, inference task information for the predicted query may be stored in the cache memory as latest inference task information. For example, the predicted query and the embedding vector of the predicted query may be stored in the cache memory as the inference task information for the predicted query. The latest inference task information may be marked with a latest inference task flag representing the latest inference task information.

Also, if it is determined that the inference task for the predicted query is performed, inference task information of an inference task that was being performed may be stored in the cache memory. For example, an answer and/or a KV matrix of the inference task that was being performed may be stored in the cache memory as the inference task information.

Also, for example, a resource for the inference task for the predicted query may be derived based on a length of the input query or a number of tokens of the input query. For example, the resource for the inference task for the predicted query may be derived as a value proportional to the length of the input query or the number of tokens of the input query.

Meanwhile, for example, if an embedding vector of inference task information whose difference from the embedding vector of the predicted query is smaller than or equal to a specific value exists, and an embedding vector of the smallest difference is an embedding vector of a specific inference task information which is not the latest inference task information, the LLM may perform an inference task of the specific inference task information to generate an answer for a predicted query of the specific inference task information. That is, for example, if it is determined that the inference task of the specific inference task information is performed, the LLM may perform the inference task of the specific inference task information to generate an answer for the predicted query of the specific inference task information.

For example, if an embedding vector of inference task information whose difference from the embedding vector of the predicted query is smaller than or equal to a specific value exists, and an embedding vector of the smallest difference is the embedding vector of a specific inference task information which is not the latest inference task information, the LLM may re-perform an inference task of the specific inference task information based on the specific inference task information to generate an answer for a predicted query of the specific inference task information. That is, for example, if it is determined that the inference task of the specific inference task information is performed, the LLM may re-perform the inference task of the specific inference task information based on the specific inference task information to generate an answer for the predicted query of the specific inference task information. For example, the specific inference task information may include an answer of the specific inference task information, and the answer for the predicted query of the specific inference task information may be generated using the answer and the KV matrix of the inference task. The LLM may re-perform the inference task of the specific inference task information to continue generating the answer of the specific inference task information.

The inference task in the LLM inference task system according to the embodiments described above may generate an answer with the predicted query derived based on the user's input query, and through this, the time for generating the answer of the inference task may be shortened and the user's satisfaction may be improved.

In addition, in the case where the similarity is high based on the embedding vector of the inference task being performed and the embedding vector of the updated predicted query, the inference task may not be interrupted, and through this, the effect of improving the efficiency of the LLM inference task system using the predicted query may be obtained.

In addition, even in the case where the embedding vector of the inference task being performed and the embedding vector of the updated predicted query have a large difference, if the embedding vector of the previously performed inference task is similar, the inference task may be performed again using the previously performed inference task information, and through this, the effect of improving the efficiency of the LLM inference task system using the predicted query may be obtained.

Although the present disclosure described above has been described with reference to the embodiments illustrated in the drawings, these are merely exemplary, and those skilled in the art will understand that various modifications and variations of the embodiments are possible. That is, the scope of the present disclosure is not limited to the above-described embodiments, and various modifications and improvements made by those skilled in the art using the basic concept of the embodiments defined in the following claims also included in the scope of the embodiments. Therefore, the scope of the present disclosure is defined by the technical spirit of the appended claims.

What is claimed is:

1. An inference task method of a Large Language Model (LLM) inference task system, the method comprising:
tokenizing an input query of a user;
deriving a predicted query based on the tokenized input query, wherein the predicted query is a sentence predicted based on the input query;
determining whether an inference task is performed for the predicted query; and
when it is determined that the inference task is performed for the predicted query, performing the inference task for the predicted query to generate an answer to the predicted query.

2. The method of claim 1, wherein the tokenizing the input query of the user comprises:
determining whether the input query is updated; and
when the input query is updated, tokenizing the updated input query,
wherein whether the input query is updated is determined in token units.

3. The method of claim 1, wherein the determining whether the inference task is performed for the predicted query comprises:
deriving an embedding vector of the predicted query; and
determining whether the inference task is performed for the predicted query based on the embedding vector of the predicted query.

4. The method of claim 3, wherein the determining whether the inference task is performed for the predicted query based on the embedding vector of the predicted query comprises:
comparing the embedding vector of the predicted query with an embedding vector of inference task information stored in a cache memory.

5. The method of claim 4, wherein the inference task information stored in the cache memory includes latest inference task information being performed and previously performed inference task information.

6. The method of claim 5, wherein when an embedding vector of inference task information whose difference from the embedding vector of the predicted query is smaller than or equal to a specific value does not exist, it is determined that the inference task for the predicted query is performed,
wherein when an embedding vector of inference task information whose difference from the embedding vector of the predicted query is smaller than or equal to the specific value exists, and an embedding vector of the smallest difference is an embedding vector of the latest inference task information, it is determined that the inference task for the predicted query is not performed, and
wherein when an embedding vector of inference task information whose difference from the embedding vector of the predicted query is smaller than or equal to the specific value exists, and an embedding vector of the smallest difference is an embedding vector of specific inference task information which is not the latest inference task information, it is determined that an inference task of the specific inference task information is performed.

7. The method of claim 6, wherein when it is determined that the inference task for the predicted query is performed, inference task information for the predicted query is stored in the cache memory as latest inference task information, and the latest inference task information is marked with a latest inference task flag representing the latest inference task information.

8. The method of claim 6, wherein when it is determined that the inference task for the predicted query is performed, an answer and a KV matrix of an inference task that was being performed are stored in the cache memory as inference task information of the inference task.

9. The method of claim 6, wherein the method further comprises:
when it is determined that the inference task of the specific inference task information is performed, re-performing the inference task of the specific inference task information based on the specific inference task information to generate an answer for a predicted query of the specific inference task information.

10. The method of claim 9, wherein the specific inference task information includes an answer and a KV matrix of the inference task of the specific inference task information, and
wherein the answer for the predicted query of the specific inference task information is generated using the answer and the KV matrix of the inference task.

11. A Large Language Model (LLM) inference task system comprising:
a tokenizer configured to tokenize an input query of a user;
an Small Language Model (SLM) configured to derive a predicted query based on the tokenized input query, wherein the predicted query is a sentence predicted based on the input query;
an LLM control unit configured to determine whether an inference task is performed for the predicted query; and
an LLM configured to, when it is determined that the inference task is performed for the predicted query, perform the inference task for the predicted query to generate an answer to the predicted query.

12. The system of claim 11, wherein the tokenizer configured to: determine whether the input query is updated; and
when the input query is updated, tokenize the updated input query,
wherein whether the input query is updated is determined in token units.

13. The system of claim 11, wherein the system further comprises:
an embedding model configured to derive an embedding vector of the predicted query, and
wherein the LLM control unit determines whether the inference task is performed for the predicted query based on the embedding vector of the predicted query.

14. The system of claim 13, wherein the LLM control unit includes a cache memory, and
wherein the LLM control unit compares the embedding vector of the predicted query with an embedding vector of inference task information stored in the cache memory.

15. The system of claim 14, wherein the inference task information stored in the cache memory includes latest inference task information being performed and previously performed inference task information.

16. The system of claim 15, wherein when an embedding vector of inference task information whose difference from the embedding vector of the predicted query is smaller than or equal to a specific value does not exist, it is determined that the inference task for the predicted query is performed,
wherein when an embedding vector of inference task information whose difference from the embedding vector of the predicted query is smaller than or equal to the specific value exists, and an embedding vector of the smallest difference is an embedding vector of the latest inference task information, it is determined that the inference task for the predicted query is not performed, and
wherein when an embedding vector of inference task information whose difference from the embedding vector of the predicted query is smaller than or equal to the specific value exists, and an embedding vector of the smallest difference is an embedding vector of specific inference task information which is not the latest inference task information, it is determined that an inference task of the specific inference task information is performed.

17. The system of claim 16, wherein when it is determined that the inference task for the predicted query is performed, inference task information for the predicted query is stored in the cache memory as latest inference task information, and the latest inference task information is marked with a latest inference task flag representing the latest inference task information.

18. The system of claim 16, wherein when it is determined that the inference task for the predicted query is performed, an answer and a KV matrix of an inference task that was being performed are stored in the cache memory as inference task information of the inference task.

19. The system of claim 16, wherein, when it is determined that the inference task of the specific inference task information is performed, the LLM re-performs the inference task of the specific inference task information based on the specific inference task information to generate an answer for a predicted query of the specific inference task information.

20. The system of claim 19, wherein the specific inference task information includes an answer and a KV matrix of the inference task of the specific inference task information, and
wherein the answer for the predicted query of the specific inference task information is generated using the answer and the KV matrix of the inference task.
